(19) United States
(12) Patent Application Publication
(10) Pub. No.: US 2009/0208731 A1
(43) Pub. Date: Aug. 20, 2009

(54) CONDUCTIVE ADHESIVE FILM, METHOD OF PRODUCING CONDUCTIVE ADHESIVE FILM, ELECTRONIC APPARATUS INCLUDING CONDUCTIVE ADHESIVE FILM, AND METHOD OF PRODUCING ELECTRONIC APPARATUS INCLUDING CONDUCTIVE ADHESIVE FILM

(75) Inventor: Munehide Saimen, Suwa-shi (JP)

Correspondence Address: ADVANTEDGE LAW GROUP, LLC, 922 W. BAXTER DRIVE, SUITE 100, SOUTH JORDAN, UT, 84095, US

(73) Assignee: Seiko Epson Corporation, Tokyo (JP)

(21) Appl. No.: 12/370,477

(22) Filed: Feb. 12, 2009

(30) Foreign Application Priority Data
Feb. 15, 2008 (JP) 2008-034119

(51) Int. Cl. B32B 5/16; B05D 5/12

(52) U.S. Cl. 428/327; 427/58

(57) ABSTRACT

A conductive adhesive film includes an insulating adhesive material and a plurality of conductive particles dispersed in the insulating adhesive material, wherein the conductive particles are arranged in the insulating adhesive material at a predetermined pitch.

### BACKGROUND

1. Technical Field

The present invention relates to a conductive adhesive film which is used for electrically connecting a first terminal to a second terminal and in which a plurality of conductive particles are dispersed in an insulating adhesive material, a method of producing the conductive adhesive film, an electronic apparatus including the conductive adhesive film, and a method of producing an electronic apparatus including the conductive adhesive film.

2. Related Art

As is generally known, in an electro-optical device which is an electronic apparatus, for example, a light-transmissive liquid crystal device, a liquid crystal panel which is an electro-optical panel in which liquid crystal is disposed between two substrates made of glass, quartz, or the like is accommodated in a packaging case or the like.

In such a liquid crystal device, switching elements such as thin film transistors (hereinafter referred to as “TFTs”) and pixel electrodes are arranged on one of the substrates of the liquid crystal panel in a matrix pattern, and a counter electrode is arranged on the other substrate. An optical response of a liquid crystal layer disposed between the substrates is changed in accordance with image signals, thus enabling image display.

A TFT substrate on which TFTs are arranged and a counter substrate disposed so as to face the TFT substrate are separately produced. Each of the TFT substrate and the counter substrate is produced by laminating a semiconductor thin film, an insulating thin film, or a conducting thin film having a predetermined pattern on, for example, a quartz substrate. The semiconductor thin film, insulating thin film, or conducting thin film is formed by repeating a step of film deposition and a step of photolithography for each layer.

For example, when liquid crystal is provided between the TFT substrate and the counter substrate by a liquid crystal injecting method, the TFT substrate and the counter substrate thus produced are bonded with high accuracy (for example, within an alignment error of 1 μm) in a step of assembling a panel with a sealing material therebetween applied onto substantially the periphery of the substrates so as to have an opening in a part.

Subsequently, alignment is performed, and the substrates are pressure-bonded to cure the sealing material. Liquid crystal is then injected through the opening provided in the part of the sealing material. The opening is then sealed with a sealant cured by heating or the like.

For example, the TFT substrate is formed so as to be larger than the counter substrate in plan view. In this case, an external connection terminal is provided on a projecting portion disposed on a part of a surface of the TFT substrate, the surface having the counter substrate thereon. A terminal (hereinafter referred to as “FPC terminal”) of a flexible printed circuit (hereinafter referred to as “FPC”) which is a flexible, thin sheet substrate (not shown) having a specific length, the FPC terminal being used for providing an electrical connection to external circuits of an electronic apparatus such as a projector, is electrically connected to the external connection terminal.

The FPC terminal is electrically connected to the external connection terminal by pressure bonding or the like via a conductive adhesive film, more specifically, via conducting particles diffused in an insulating adhesive material of the conductive adhesive film. Finally, the liquid crystal panel is accommodated in a packaging case or the like, thus producing a liquid crystal device.

The following method is known as a method of electrically connecting an FPC terminal to an external connection terminal. A commercially available general-purpose conductive adhesive film is cut to a predetermined size. The conductive adhesive film having the predetermined size is then applied to either the external connection terminal or the FPC terminal. Thereby, the FPC terminal is electrically connected to the external connection terminal with the applied conductive adhesive film therebetween. The use of this method is not limited to forming an electrical connection between an external connection terminal and an FPC terminal. Similarly, this method is generally used for forming an electrical connection between terminals using a conductive adhesive film.

Such a conductive adhesive film used for providing an electrical connection between terminals is disclosed in, for example, JP-A-2007-211122.

In general, in commercially available general-purpose conductive adhesive films or in an insulating adhesive material of the conductive adhesive film disclosed in JP-A-2007-211122, conductive particles are dispersed at a high density. For example, 5,000 conductive particles having a particle diameter of, for example, 3 μm are dispersed per 1 mm² of an insulating adhesive material.

The reason why conductive particles are dispersed at a high density is as follows. When an electrical connection between terminals is established, for example, when a first terminal including a plurality of terminal portions is electrically connected to a second terminal including a plurality of terminal portions with a conductive adhesive film therebetween, by reliably positioning the conductive particles between a pair of terminal portions facing the first terminal and the second terminal, the pair of terminal portions facing each other are reliably electrically connected via the conductive particles located between the terminal portions.

However, when the conductive particles are dispersed in the insulating adhesive material of the conductive adhesive film at a high density, the following problem occurs. When the second terminal is electrically connected to the first terminal via the conductive adhesive film, the conductive particles may be located at positions other than the position between the pair of facing terminal portions. More specifically, a large number of conductive particles which are not used for electrically connecting the terminal portions are dispersed in the insulating adhesive material, that is, all the conductive particles are not used for the electrical connection between the terminal portions. Therefore, the use of such a conductive adhesive film in which a large number of conductive particles which are not used for electrical connection between terminal portions are dispersed is not economical.

Furthermore, in preparation of a conductive adhesive film, in order to improve connection reliability between a first terminal and a second terminal, the dispersion density of conductive particles in the insulating adhesive material must be considered so that the conductive particles are reliably located between facing terminal portions of the terminals. This consideration is very complex.

### SUMMARY

An advantage of some aspects of the invention is to provide a conductive adhesive film for which the production cost is reduced and connection reliability between terminals is easily improved in an electrical connection between the terminals using the conductive adhesive film, a method of producing the conductive adhesive film, an electronic apparatus including the conductive adhesive film, and a method of producing an electronic apparatus including the conductive adhesive film.

According to a first aspect of the invention, a conductive adhesive film includes an insulating adhesive material, and a plurality of conductive particles dispersed in the insulating adhesive material, wherein the conductive particles are arranged in the insulating adhesive material at a predetermined pitch.

In this conductive adhesive film, a plurality of conductive particles are arranged in an insulating adhesive material at a predetermined pitch. Accordingly, when a first terminal is bonded to a second terminal with the conductive adhesive film therebetween, the conductive particles can be reliably arranged only between the first terminal and the second terminal. Consequently, connection reliability between the first terminal and the second terminal via the conductive particles can be easily improved.

According to a second aspect of the invention, a conductive adhesive film includes an insulating adhesive material, and a plurality of conductive particles dispersed in the insulating adhesive material, wherein an area having a high density of the conductive particles and an area having a low density of the conductive particles are alternately arranged at a predetermined pitch.

In this conductive adhesive film, a plurality of conductive particles are arranged in an insulating adhesive material so that an area having a high density of the conductive particles and an area having a low density of the conductive particles are alternately arranged at a predetermined pitch. Accordingly, when a first terminal is bonded to a second terminal with the conductive adhesive film therebetween, the conductive particles can be reliably arranged only between the first terminal and the second terminal. Consequently, connection reliability between the first terminal and the second terminal via the conductive particles can be easily improved.

In the conductive adhesive film, it is preferable that the conductive adhesive film electrically connects a first terminal to a second terminal, each of the first terminal and the second terminal includes a plurality of terminal portions arranged in a first direction, and the pitch is determined in accordance with a pitch of the terminal portions in the first direction.

In this conductive adhesive film, a plurality of conductive particles are arranged on an insulating adhesive material in accordance with a pitch of a plurality of terminal portions constituting each of the first terminal and the second terminal in the first direction. Accordingly, when the first terminal is bonded to the second terminal with the conductive adhesive film therebetween, the conductive particles can be reliably arranged only at positions where a terminal portion of the first terminal faces the corresponding terminal portion of the second terminal. Consequently, connection reliability between the first terminal and the second terminal can be easily improved.

The conductive particles preferably have a particle diameter substantially the same as a width of the terminal portions of the first terminal and the second terminal in the first direction.

In this case, a plurality of conductive particles have a particle diameter substantially the same as a width of the terminal portions of the first terminal and the second terminal in the first direction. Accordingly, when the first terminal is bonded to the second terminal with the conductive adhesive film therebetween, a single conductive particle having a predetermined particle diameter can be reliably arranged only at each of the positions where a terminal portion of the first terminal faces the corresponding terminal portion of the second terminal. Consequently, connection reliability between the first terminal and the second terminal can be easily improved.

Furthermore, the conductive particles may be metal particles.

In this conductive adhesive film, a plurality of conductive particles composed of metal particles are arranged on an insulating adhesive material at a predetermined pitch. Accordingly, when the first terminal is bonded to the second terminal with the conductive adhesive film therebetween, the conductive particles composed of metal particles can be reliably arranged only between the first terminal and the second terminal. Consequently, connection reliability between the first terminal and the second terminal can be easily improved.

Alternatively, the conductive particles may be resin core particles each composed of a resin coated with a metal plating film.

In this conductive adhesive film, a plurality of conductive particles composed of resin core particles are arranged on an insulating adhesive material at a predetermined pitch. Accordingly, when the first terminal is bonded to the second terminal with the conductive adhesive film therebetween, the conductive particles composed of resin core particles can be reliably arranged only between the first terminal and the second terminal. Consequently, connection reliability between the first terminal and the second terminal can be easily improved.

Furthermore, it is preferable that the conductive particles electrically connect the first terminal to the second terminal.

In this case, when the first terminal is bonded to the second terminal with the conductive adhesive film therebetween, connection reliability between the first terminal and the second terminal can be easily improved by the conductive particles arranged between the first terminal and the second terminal.

It is also preferable that the conductive particles are melted by applying heat and electrically connect the first terminal to the second terminal by eutectic bonding.

In this case, when the first terminal is bonded to the second terminal with the conductive adhesive film therebetween, connection reliability between the first terminal and the second terminal can be easily improved by eutectic bonding formed by melting the conductive particles arranged only between the first terminal and the second terminal.

According to a third aspect of the invention, a method of producing a conductive adhesive film including an insulating adhesive material and a plurality of conductive particles dispersed in the insulating adhesive material includes placing the conductive particles on the insulating adhesive material so that the conductive particles are arranged in the insulating adhesive material at a predetermined pitch.

The method of producing a conductive adhesive film according to the third aspect of the invention includes placing a plurality of conductive particles on an insulating adhesive material so that the conductive particles are arranged on the insulating adhesive material at a predetermined pitch. Accordingly, when a first terminal is bonded to a second terminal with the conductive adhesive film therebetween, the conductive particles can be reliably arranged only between the first terminal and the second terminal, and thus connection reliability between the first terminal and the second terminal can be easily improved. In addition, the conductive adhesive film is produced by placing conductive particles, the number of which is the minimum required for connecting between the terminals, at predetermined positions of the insulating adhesive material, and the resulting film is used for electrically connecting the first terminal to the second terminal. Therefore, the production cost can be reduced compared with a case where a general-purpose conductive adhesive film in which a plurality of conductive particles are diffused in an insulating adhesive material at a high density is used for the electrical connection.

According to a fourth aspect of the invention, a method of producing a conductive adhesive film including an insulating adhesive material and a plurality of conductive particles dispersed in the insulating adhesive material includes placing the conductive particles on the insulating adhesive material so that an area having a high density of the conductive particles and an area having a low density of the conductive particles are alternately arranged at a predetermined pitch.

The method of producing the conductive adhesive film according to the fourth aspect of the invention includes placing a plurality of conductive particles on an insulating adhesive material so that an area having a high density of the conductive particles and an area having a low density of the conductive particles are alternately arranged at a predetermined pitch. Accordingly, when a first terminal is bonded to a second terminal with the conductive adhesive film therebetween, the conductive particles can be reliably arranged only between the first terminal and the second terminal, and thus connection reliability between the first terminal and the second terminal can be easily improved.

It is preferable that the conductive adhesive film electrically connects a first terminal to a second terminal, each of the first terminal and the second terminal includes a plurality of terminal portions arranged in a first direction, and the placement of the conductive particles on the insulating adhesive material at a predetermined pitch is performed in accordance with a pitch of the terminal portions in the first direction.

In this case, the method of producing the conductive adhesive film includes placing a plurality of conductive particles so that the conductive particles are arranged on the insulating adhesive material in accordance with the pitch of the plurality of terminal portions constituting each of the first terminal and the second terminal in the first direction. Accordingly, when the first terminal is bonded to the second terminal with the conductive adhesive film therebetween, the conductive particles can be reliably arranged only between the first terminal and the second terminal, and thus connection reliability between the first terminal and the second terminal can be easily improved. In addition, a conductive adhesive film is produced by placing conductive particles, the number of which is the minimum required for connecting between the terminals, at predetermined positions of the insulating adhesive material, and the resulting film is used for electrically connecting the first terminal to the second terminal. Therefore, the production cost can be reduced compared with a case where a general-purpose conductive adhesive film in which a plurality of conductive particles are diffused in an insulating adhesive material at a high density is used for the electrical connection.

Furthermore, the placement of the conductive particles may be performed using a dispenser.

Alternatively, the placement of the conductive particles may be performed by a method of producing a package of an electronic component including sucking the conductive particles into a structure having suction holes provided at the predetermined pitch, and placing the sucked conductive particles from the structure onto the insulating adhesive material.

Alternatively, the placement of the conductive particles may be performed using a droplet discharge unit.

Alternatively, the placement of the conductive particles may be performed by printing.

In the above cases, a plurality of conductive particles can be reliably arranged on an insulating adhesive material with high positional accuracy at a predetermined pitch by using any one of a dispenser, a method of producing a package of an electronic component, a droplet discharge unit, and printing.

According to a fifth aspect of the invention, an electronic apparatus includes the conductive adhesive film according to the first aspect of the invention, wherein the conductive adhesive film is used for providing an electrical connection between a first terminal and a second terminal.

In the conductive adhesive film, a plurality of conductive particles are arranged on an insulating adhesive material at a predetermined pitch. Accordingly, when a first terminal is bonded to a second terminal with the conductive adhesive film therebetween, the conductive particles can be reliably arranged only between the first terminal and the second terminal. Consequently, the fifth aspect of the invention can provide an electronic apparatus in which connection reliability between the first terminal and the second terminal is easily improved.

According to a sixth aspect of the invention, in a method of producing an electronic apparatus including a conductive adhesive film, a conductive adhesive film in which a plurality of conductive particles are dispersed by being arranged in an insulating adhesive material at a predetermined pitch is used for providing an electrical connection between a first terminal and a second terminal.

According to the sixth aspect of the invention, a first terminal is electrically connected to a second terminal using a conductive adhesive film in which a plurality of conductive particles are arranged in an insulating adhesive material at a predetermined pitch. Accordingly, when the first terminal is bonded to the second terminal with the conductive adhesive film therebetween, the conductive particles can be reliably arranged only between the first terminal and the second terminal. Consequently, the sixth aspect of the invention can provide a method of producing an electronic apparatus including a conductive adhesive film in which connection reliability between the first terminal and the second terminal can be easily improved.

### BRIEF DESCRIPTION OF THE DRAWINGS

The invention will be described with reference to the accompanying drawings, wherein like numbers reference like elements.

FIG. 1 is a plan view showing a liquid crystal panel of a liquid crystal device including a conducting adhesive film according to an embodiment, together with an FPC.

FIG. 2 is a cross-sectional view of the liquid crystal panel and the FPC taken along line II-II in FIG. 1.

FIG. 3 is a cross-sectional view of the liquid crystal panel taken along line III-III in FIG. 1.

FIG. 4 is an enlarged cross-sectional view showing a conductive particle composed of a metal particle shown in FIG. 3.

FIG. 5 is an enlarged cross-sectional view showing a modification in which a conductive particle is composed of a resin core particle.

FIG. 6 is a cross-sectional view showing a state in which terminal portions of an external connection terminal are electrically connected to terminal portions of an FPC terminal by eutectic bonding formed by melting of conductive particles.

FIG. 7 is a partially enlarged cross-sectional view showing a state in which a terminal portion of an external connection terminal is electrically connected to a terminal portion of an FPC terminal by eutectic bonding formed by melting of a conductive particle composed of a metal particle.

FIG. 8 is a partially enlarged cross-sectional view showing a state in which a terminal portion of an external connection terminal is electrically connected to a terminal portion of an FPC terminal by eutectic bonding formed by melting of a metal plating film of a conductive particle composed of a resin core particle.

FIG. 9 is a plan view showing a conductive adhesive film composed of only an insulating adhesive material cut to a predetermined size.

FIG. 10 is a plan view showing a state in which conductive particles are arranged in the insulating adhesive material shown in FIG. 9 at a predetermined pitch in the width direction.

FIG. 11 is a partial cross-sectional view showing a method of placing a plurality of conductive particles on an insulating adhesive material using dispensers.

FIG. 12 is a perspective view showing a state in which suction is performed from each of suction holes so that a plurality of conductive particles are arranged in a bonding tool at a predetermined pitch.

FIG. 13 is a cross-sectional view showing a method of placing the plurality of conductive particles sucked in each of the suction holes of the bonding tool shown in FIG. 12 on an insulating adhesive material.

FIG. 14 is a cross-sectional view showing a method of placing a plurality of conductive particles on an insulating adhesive material by an ink jet method.

FIG. 15 is a partial cross-sectional view showing a method of placing a plurality of conductive particles on an insulating adhesive material by printing using a mask.

FIG. 16 is a view that schematically shows a state in which a conductive adhesive film is applied on an external connection terminal of a liquid crystal panel.

### DESCRIPTION OF EXEMPLARY EMBODIMENTS

Embodiments of the invention will now be described with reference to the drawings. In the embodiments described below, an electronic apparatus including a conductive adhesive film will be described using an electro-optical device as an example. The electro-optical device will be described using a light-transmissive liquid crystal device as an example. Accordingly, an electro-optical panel of the electro-optical device will be described using a liquid crystal panel as an example.

Regarding a pair of substrates disposed so as to face each other in the liquid crystal panel, one of the substrates will be described using an element substrate (hereinafter referred to as “TFT substrate”) as an example, and the other substrate will be described using a counter substrate facing the TFT substrate as an example.

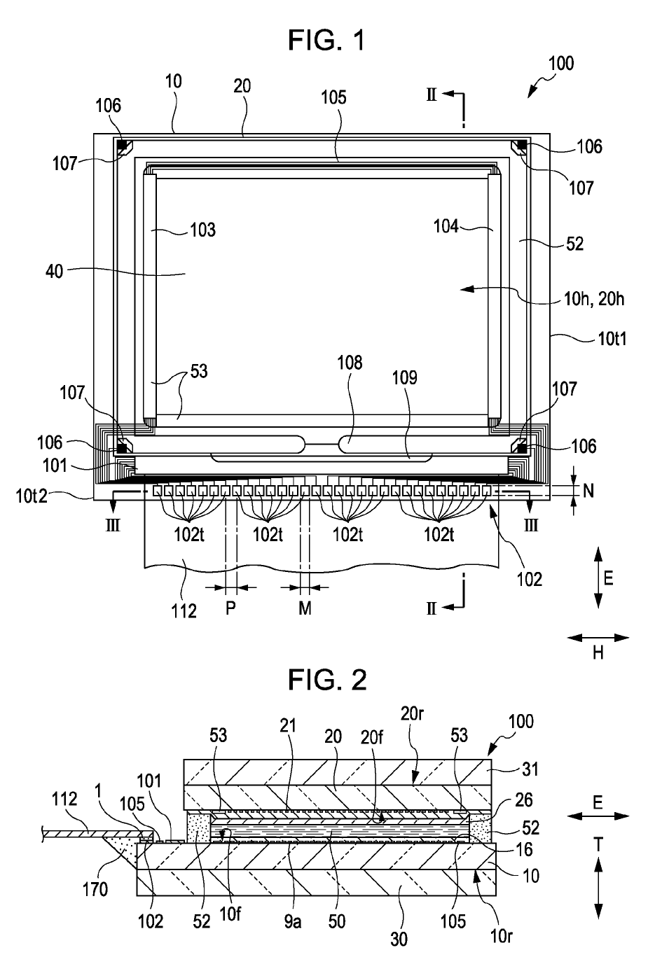

Prior to a description of the structure of a conductive adhesive film of this embodiment, the structure of a liquid crystal device including a conductive adhesive film will be described with reference to FIGS. 1 and 2. FIG. 1 is a plan view showing a liquid crystal panel of the liquid crystal device including the conducting adhesive film according to this embodiment, together with an FPC. FIG. 2 is a cross-sectional view of the liquid crystal panel and the FPC taken along line II-II in FIG. 1.

As shown in FIGS. 1 and 2, a liquid crystal panel 100 includes a TFT substrate 10 made of, for example, quartz or glass and a counter substrate 20 disposed so as to face the TFT substrate 10 and made of, for example, glass or quartz. The outer shape of the counter substrate 20 is smaller than that of the TFT substrate 10. Liquid crystal 50 is disposed in an inner space between the TFT substrate 10 and the counter substrate 20. The TFT substrate 10 and the counter substrate 20, which face each other, are bonded with a sealing material 52.

A display area 10h of the TFT substrate 10 constituting a display area 40 of the liquid crystal panel 100 is provided in an area of the TFT substrate 10, the area contacting the liquid crystal 50. Pixel electrodes 9a that constitute pixels and that apply a drive voltage to the liquid crystal 50 together with a counter electrode 21 described below are arranged in a matrix pattern in the display area 10h at a surface 10f side of the TFT substrate 10, the surface 10f facing the counter substrate 20.

The counter electrode 21 that applies a drive voltage to the liquid crystal 50 together with the pixel electrodes 9a is provided in an area of a surface 20f side of the counter substrate 20, the area contacting the liquid crystal 50. A display area 20h of the counter substrate 20 constituting the display area 40 of the liquid crystal panel 100 is provided in an area of the counter electrode 21, the area facing the display area 10h.

An alignment layer 16 which has been subjected to a rubbing treatment is provided on the pixel electrodes 9a on the TFT substrate 10. An alignment layer 26 which has been subjected to a rubbing treatment is further provided on the counter electrode 21 formed over the entire surface of the counter substrate 20. Each of the alignment layers 16 and 26 is composed of, for example, a transparent organic film such as a polyimide film.

In the display area 10h of the TFT substrate 10, a plurality of scanning lines (not shown) and a plurality of data lines (not shown) are arranged so as to cross each other. The pixel electrodes 9a are arranged in a matrix pattern in areas defined by the scanning lines and the data lines. TFTs (not shown) are provided so as to correspond to positions at which the scanning lines and the data lines cross each other. Each of the pixel electrodes 9a is electrically connected to the corresponding TFT.

The TFT turns to then ON state by an ON signal of the scanning line. Consequently, an image signal supplied to the data line is supplied to the pixel electrode 9a. A voltage between the pixel electrode 9a and the counter electrode 21, which is provided on the counter substrate 20, is applied to the liquid crystal 50.

A light-shielding film 53 serving as a frame specifying the display area 40 of the liquid crystal panel 100 is provided on the counter substrate 20.

In the case where the liquid crystal 50 is injected into a space between the TFT substrate 10 and the counter substrate 20 by a known liquid crystal injecting method, the sealing material 52 is applied so that the sealing material 52 is not provided in a part of one side of the sealing material 52.

The part in which the sealing material 52 is not provided constitutes a liquid crystal inlet 108 functioning as an opening through which the liquid crystal 50 is injected into the area surrounded by the sealing material 52 in a space between the TFT substrate 10 and the counter substrate 20 which are bonded to each other at the periphery except for at the part. The liquid crystal inlet 108 is sealed with a sealant 109 after the injection of the liquid crystal 50.

On the surface 10f of the TFT substrate 10, a data-line driving circuit 101 and an external connection terminal 102 are provided in an area outside the sealing material 52 on a side face side in a width direction H which is a first direction connecting an edge 10t1 of the TFT substrate 10 to another edge 10t2 of the TFT substrate 10. The data-line driving circuit 101 is a driver that supplies data lines (not shown) of the TFT substrate 10 with image signals at a predetermined timing to drive the data lines. The external connection terminal 102 is a first terminal for connecting to external circuits.

Alternatively, the external connection terminal 102 may be provided on the counter substrate 20. The external connection terminal 102 includes a plurality of terminal portions 102t. Each of the terminal portions 102t is made of an electrically conductive material such as aluminum or indium tin oxide (ITO).

Furthermore, FIG. 1 does not show the specific number of pins of the terminal portions 102t, but in general, the number of terminal portions 102t of the external connection terminal 102 is about 100 to 1,000 pins. An appropriate number of terminal portions 102t are provided depending on the type of the liquid crystal panel.

A width M of each of the terminal portions 102t in the width direction H is, for example, about 14 μm, but the width M is not limited to 14 μm. Furthermore, a width N of each of the terminal portions 102t in an extending direction E of an FPC 112 is, for example, about 500 μm. The width N is also not limited to 500 μm.

Furthermore, for example, when the number of pins of the terminal portions 102t is 500 and the width M of each of the terminal portions 102t is 14 μm, a pitch P of the terminal portions 102t in the width direction H is, for example, 50 μm. The pitch P of the terminal portions 102t is also not limited to 50 μm.

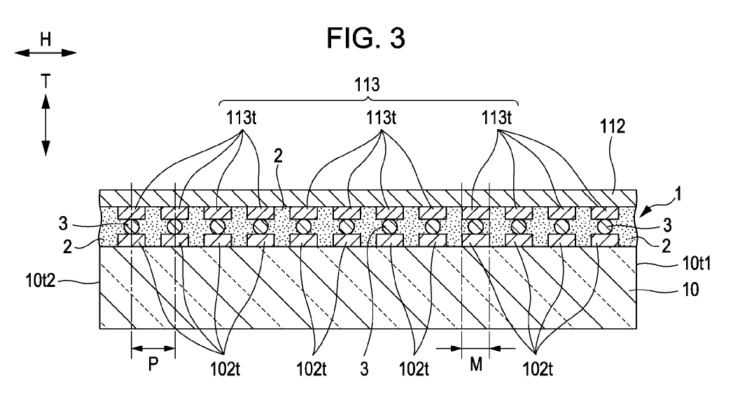

An FPC terminal 113 (see FIG. 3) is electrically connected to the external connection terminal 102 by, for example, pressure bonding with a conductive adhesive film 1 therebetween. The FPC terminal 113 is a second terminal provided at an end of the FPC 112 that provides an electrical connection between the liquid crystal panel 100 and an electronic apparatus such as a projector (not shown) and that has a specific length. The structure of the conductive adhesive film 1 and the connection structure between the external connection terminal 102 and the FPC terminal 113 will be described below. The liquid crystal panel 100 is electrically connected to the external circuits by connecting another end of the FPC 112 to the external circuits.

The FPC terminal 113 also includes a plurality of terminal portions 113t. The number of pins of the terminal portions 113t is the same as the number of pins of the terminal portions 102t of the external connection terminal 102. That is, when the number of pins of the terminal portions 102t of the external connection terminal 102 is 500, the number of pins of the terminal portions 113t of the FPC terminal 113 is also 500.

The width M of each of the terminal portions 113t in the width direction H is also, for example, about 14 μm. The width M of each of the terminal portions 113t is also not limited to 14 μm. Furthermore, the width N of each of the terminal portions 113t in the extending direction E is, for example, about 500 μm. The width N is also not limited to 500 μm.

Furthermore, for example, when the number of pins of the terminal portions 113t is 500 and the width M of each of the terminal portions 113t is 14 μm, the pitch P of the terminal portions 113t in the width direction H is, for example, 50 μm. The pitch P of the terminal portions 113t is also not limited to 50 μm.

When the FPC terminal 113 is electrically connected to the external connection terminal 102, each of the terminal portions 113t is located so as to face the corresponding terminal portion 102t in a thickness direction T of the liquid crystal panel 100, which is a second direction, as shown in FIG. 3 described below.

Each of the terminal portions 113t is composed of, for example, a copper film on which nickel and gold films are formed by plating, a copper film on which a gold film is formed by plating, or a copper film on which a tin film is formed by plating. The materials constituting the terminal portions 113t are not limited to the above materials.

In order to reinforce the electrical connection between the external connection terminal 102 and the FPC terminal 113, for example, a photocurable adhesive 170 is linearly provided between the FPC 112 and a side face of the TFT substrate 10 in the width direction H.

Scanning-line driving circuits 103 and 104 are provided on the surface 10f of the TFT substrate 10 along side faces adjacent to a side face of the TFT substrate 10, the side face having the external connection terminal 102 thereon. The scanning-line driving circuits 103 and 104 are drivers that drive gate electrodes by supplying the scanning lines and the gate electrodes (not shown) of the TFT substrate 10 with scanning signals at a predetermined timing. The scanning-line driving circuits 103 and 104 are provided on the surface 10f of the TFT substrate 10 at positions facing the light-shielding film 53 disposed inside the sealing material 52.

Furthermore, wiring 105 connecting the data-line driving circuit 101, the scanning-line driving circuits 103 and 104, the external connection terminal 102, and vertically conducting terminals 107 are provided on the surface 10f of the TFT substrate 10 so as to face three sides of the light-shielding film 53.

The vertically conducting terminals 107 are provided on the TFT substrate 10 at four positions of the corners of the sealing material 52. Furthermore, vertically conducting members 106 are provided between the TFT substrate 10 and the counter substrate 20. The lower end of each of the vertically conducting members 106 is in contact with the vertically conducting terminal 107, and the upper end thereof is in contact with the counter electrode 21. The TFT substrate 10 is electrically connected to the counter substrate 20 with the vertically conducting members 106 therebetween.

A cover glass 30 is bonded on a reverse face 10r of the TFT substrate 10. Similarly, a cover glass 31 is bonded on a reverse face 20r of the counter substrate 20.

The cover glasses 30 and 31 prevent dust or the like from being attached to at least the display areas 10h and 20h of the reverse faces 10r and 20r of the TFT substrate 10 and the counter substrate 20, respectively. In addition, the cover glasses 30 and 31 have a function of making images of dust or the like invisible by separating the dust or the like from the reverse face 10r and 20r, respectively, and causing images of them to be defocused.

Next, the structure of the conductive adhesive film 1 and the connection structure between the external connection terminal 102 and the FPC terminal 113 will be described with reference to FIGS. 3 to 8.

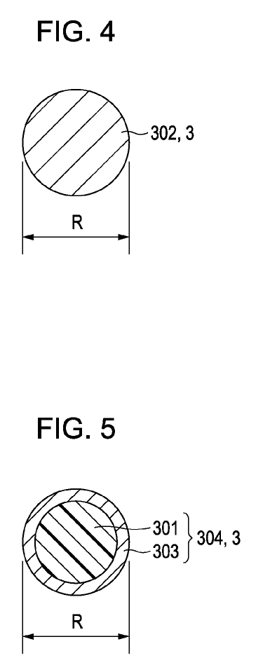

FIG. 3 is a cross-sectional view of the liquid crystal panel 100 taken along line III-III in FIG. 1. FIG. 4 is an enlarged cross-sectional view showing a conductive particle composed of a metal particle shown in FIG. 3. FIG. 5 is an enlarged cross-sectional view showing a modification in which a conductive particle is composed of a resin core particle.

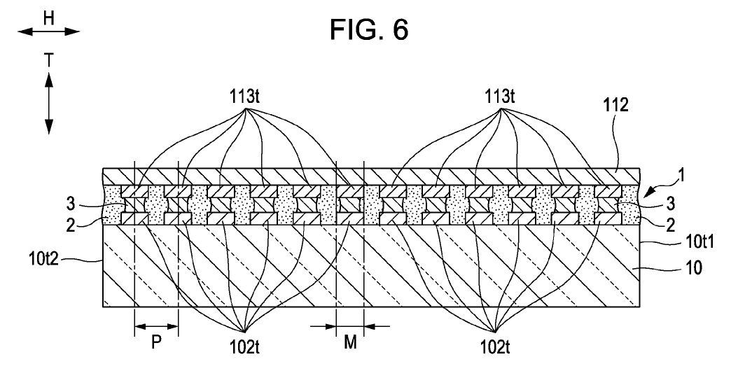

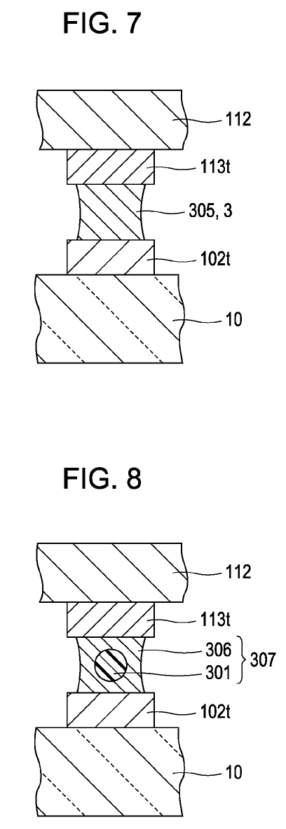

FIG. 6 is a cross-sectional view showing a state in which terminal portions of an external connection terminal are electrically connected to terminal portions of an FPC terminal by eutectic bonding formed by melting of conductive particles. FIG. 7 is a partially enlarged cross-sectional view showing a state in which a terminal portion of an external connection terminal is electrically connected to a terminal portion of an FPC terminal by eutectic bonding formed by melting of a conductive particle composed of a metal particle. FIG. 8 is a partially enlarged cross-sectional view showing a state in which a terminal portion of an external connection terminal is electrically connected to a terminal portion of an FPC terminal by eutectic bonding formed by melting of a metal plating film of a conductive particle composed of a resin core particle.

In FIGS. 3 and 6, in order to simplify the figures, the number of terminal portions of an external connection terminal and the number of terminal portions of the FPC terminal are smaller than those of FIG. 1. In addition, in FIGS. 3 and 6, the number of conductive particles is also smaller than the actual number of conductive particles in accordance with the number of terminal portions.

As shown in FIG. 3, as described above, an FPC terminal 113 is electrically connected to an external connection terminal 102 with a conductive adhesive film 1 therebetween.

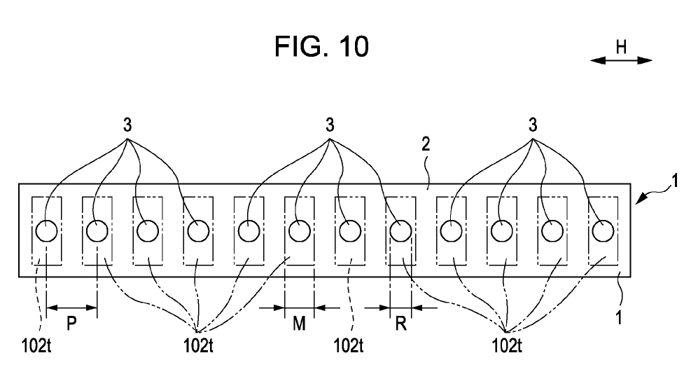

The conductive adhesive film 1 includes an insulating adhesive material 2 and, for example, spherical conductive particles 3. As shown in FIG. 10 described below, the conductive particles 3 are arranged and diffused in the insulating adhesive material 2 at a predetermined pitch. As shown in FIG. 4, each of the conductive particles 3 is composed of a metal particle 302 made of, for example, nickel, gold, silver, copper, aluminum, tin, palladium, ITO, or carbon.

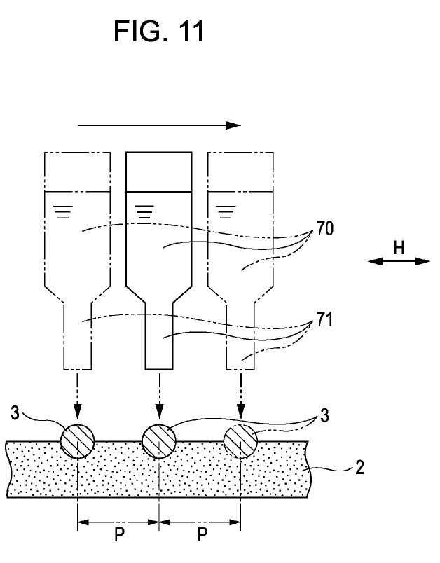

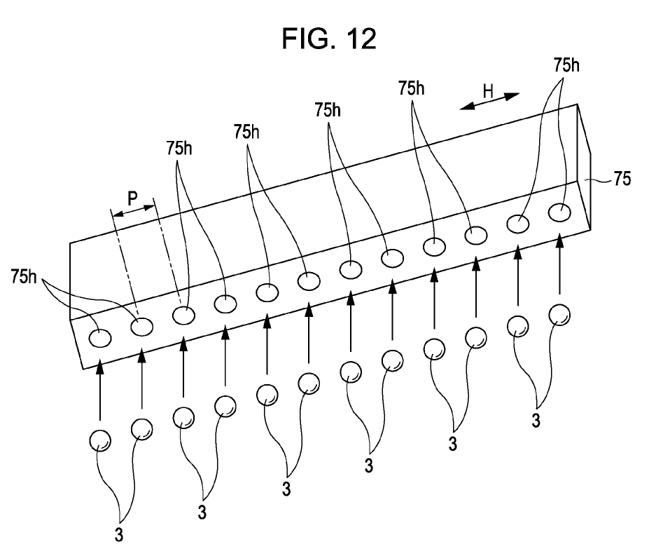

As the conductive adhesive film 1 used in the liquid crystal panel 100, a commercially available conductive adhesive film in which conductive particles 3 are arranged in an insulating adhesive material 2 at a predetermined pitch may be used. Alternatively, a conductive adhesive film may be prepared by any one of methods shown in FIGS. 11 to 15 so that conductive particles 3 are arranged in an insulating adhesive material 2 at a predetermined pitch, and the conductive adhesive film may be used as the conductive adhesive film 1.

A particle diameter R of the conductive particles 3 is substantially the same as the width M of the terminal portions 102t and the terminal portions 113t in the width direction H, or somewhat smaller than the width M. More specifically, when the width M of the terminal portions 102t and the terminal portions 113t in the width direction H is 14 μm, the particle diameter R of the conductive particles 3 is about 10 μm. The particle diameter R of the conductive particles 3 is not limited to 10 μm. The shape of the conductive particles 3 is not limited to a spherical shape.

The conductive particle 3 is not limited to the metal particle 302 shown in FIG. 4. Alternatively, as shown in FIG. 5, the conductive particle 3 may be a resin core particle 304 composed of a spherical resin 301 whose surface is coated with a metal plating film 303 made of, for example, nickel, gold, silver, copper, aluminum, tin, palladium, ITO, or carbon.

Furthermore, as shown in FIG. 10 described below, the conductive particles 3 are arranged in the insulating adhesive material 2 in the width direction H at the same predetermined pitch as the pitch P of the terminal portions 102t and the terminal portions 113t in the width direction H. Hereinafter, the predetermined pitch of the conductive particles 3 in the width direction H is also assigned symbol P.

More specifically, when each of the number of pins of the terminal portions 102t and the number of pins of the terminal portions 113t is, for example, 500 and the pitch P of the terminal portions in the width direction H is 50 μm, 500 conductive particles 3 are arranged in the insulating adhesive material 2 at a pitch of 50 μm in the width direction H.

As shown in FIG. 3, the conductive adhesive film 1 is applied to the external connection terminal 102 with high accuracy so that the conductive particle 3 is located only on each of the terminal portions 102t, and the FPC terminal 113 is pressure-bonded to the external connection terminal 102 with the conductive adhesive film 1 therebetween so that each of the terminal portions 102t faces the corresponding terminal portion 113t in the thickness direction T. Consequently, each of the terminal portions 102t and the corresponding terminal portion 113t are electrically connected via the conductive particle 3, which is arranged between each of the terminal portions 102t and the corresponding terminal portion 113t in the width direction H.

In this case, as described above, the conductive particles 3 are arranged at the same pitch as the pitch of the terminal portions 102t and the terminal portions 113t in the width direction H. Therefore, as shown in FIG. 3, in the insulating adhesive material 2 of the conductive adhesive film 1, the conductive particles 3 are not located at positions other than the positions where the terminal portions 102t face the terminal portions 113t.

As shown in FIG. 6, each of the terminal portions 102t may be electrically connected to the corresponding terminal portions 113t by eutectic bonding formed by melting the conductive particles 3 arranged in the width direction H as described above by applying heat to the conductive particles 3.

More specifically, as shown in FIG. 7, when the conductive particle 3 is composed of a metal particle 305 having a melting point of 500° C. or lower, for example, a solder or tin particle, each of the terminal portions 102t is electrically connected to the corresponding terminal portions 113t as follows. The FPC terminal 113 is pressure-bonded to the external connection terminal 102 with the conductive adhesive film 1 therebetween, the metal particle 305 is then melted by heat applied to the conductive adhesive film 1 during the pressure bonding. Consequently, each of the terminal portions 102t is electrically connected to the corresponding terminal portions 113t by eutectic bonding.

Alternatively, as shown in FIG. 8, when the conductive particle 3 is a resin core particle 307 composed of a spherical resin 301 whose surface is coated with a metal plating film 306 having a melting point of 500° C. or lower, for example, a solder or tin film, each of the terminal portions 102t is electrically connected to the corresponding terminal portions 113t as follows. The FPC terminal 113 is pressure-bonded to the external connection terminal 102 with the conductive adhesive film 1 therebetween, the metal plating film 306 is then melted by heat applied to the conductive adhesive film 1 during the pressure bonding. Consequently, each of the terminal portions 102t is electrically connected to the corresponding terminal portions 113t by eutectic bonding.

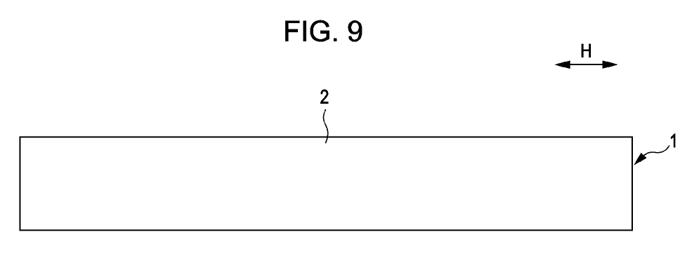

Next, a method of producing the conductive adhesive film shown in FIGS. 3 and 6 will be described with reference to FIGS. 9 and 10. FIG. 9 is a plan view showing a conductive adhesive film composed of only an insulating adhesive material cut to a predetermined size. FIG. 10 is a plan view showing a state in which conductive particles are arranged in the insulating adhesive material shown in FIG. 9 at a predetermined pitch in the width direction.

In order to simplify the figure, the number of terminal portions of an external connection terminal in FIG. 10 is smaller than that in FIG. 1. In addition, in FIG. 10, the number of conductive particles is also smaller than the actual number of conductive particles in accordance with the number of terminal portions of the external connection terminal.

In producing the conductive adhesive film 1 shown in FIGS. 3 and 6, first, as shown in FIG. 9, a conductive adhesive film 1 composed of only an insulating adhesive material 2 is cut in the width direction H to a long shape having a predetermined size. For example, when the conductive adhesive film 1 is applied to the external connection terminal 102, the conductive adhesive film 1 is cut to substantially the same size as the outer shape of the external connection terminal 102 or a size somewhat larger than the outer shape of the external connection terminal 102.

Next, a plurality of conductive particles 3 are placed by a method described below so that the conductive particles 3 are arranged on the insulating adhesive material 2 of the conductive adhesive film 1 cut to have the predetermined size in the width direction H at a predetermined pitch.

Specifically, a plurality of conductive particles 3 are placed on the insulating adhesive material 2 of the conductive adhesive film 1 cut to have the predetermined size in the width direction H at the same predetermined pitch as the pitch P of the terminal portions 102t of the external connection terminal 102 and the terminal portions 113t of the FPC terminal 113 in the width direction H.

More specifically, for example, when each of the number of pins of the terminal portions 102t and the number of pins of the terminal portions 113t is 500 and the width M of each of the terminal portions 102t and 113t is 14 μm, each of the distance between the terminal portions 102t and the distance between the terminal portions 113t is, for example, 50 μm in the width direction H. In this case, 500 conductive particles 3 are placed on the insulating adhesive material 2 at a pitch of 50 μm in the width direction H.

As a result, as shown in FIGS. 3 and 6, the conductive adhesive film 1 in which the conductive particles 3 are arranged in the insulating adhesive material 2 in the width direction H at a pitch of 50 μm is produced.

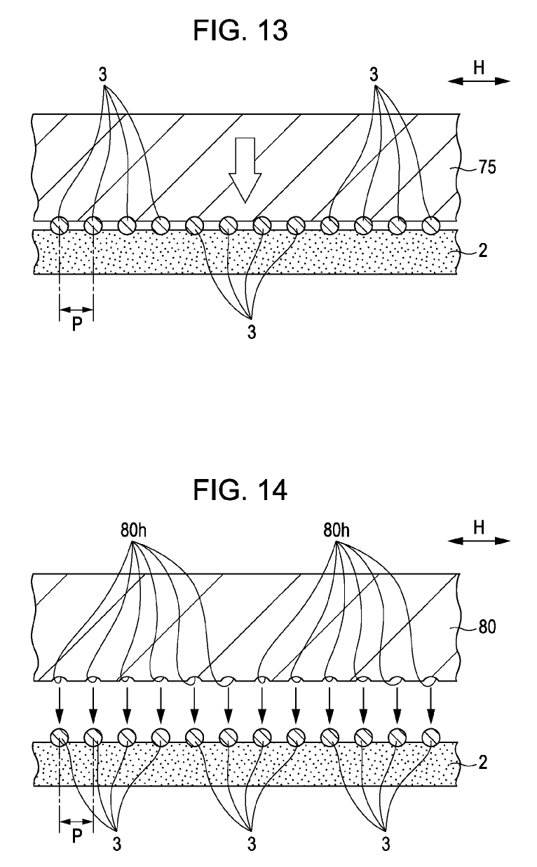

Next, specific methods of placing a plurality of conductive particles 3 on an insulating adhesive material 2 at a predetermined pitch will be described with reference to FIGS. 11 to 15. FIG. 11 is a partial cross-sectional view showing a method of placing a plurality of conductive particles on an insulating adhesive material using dispensers. FIG. 12 is a perspective view showing a state in which suction is performed from each of suction holes so that a plurality of conductive particles are arranged in a bonding tool at a predetermined pitch. FIG. 13 is a cross-sectional view showing a method of placing the plurality of conductive particles sucked in each of the suction holes of the bonding tool shown in FIG. 12 on an insulating adhesive material.

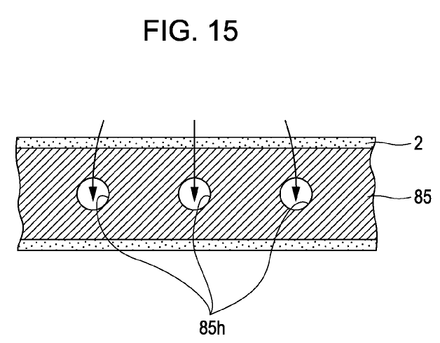

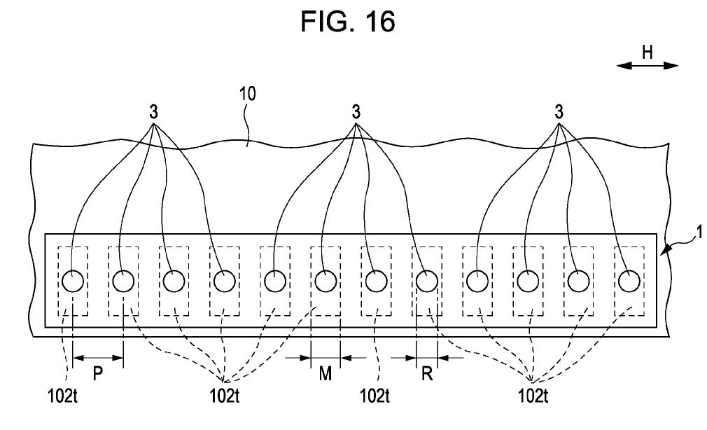

FIG. 14 is a cross-sectional view showing a method of placing a plurality of conductive particles on an insulating adhesive material by an ink jet method. FIG. 15 is a partial cross-sectional view showing a method of placing a plurality of conductive particles on an insulating adhesive material by printing using a mask.

In FIGS. 12 to 14, in order to simplify the figures, the number of conductive particles 3 is smaller than the actual number of conductive particles 3.

A first method of placing a plurality of conductive particles 3 on an insulating adhesive material 2 at a predetermined pitch P is a method of using a dispenser.

Specifically, as shown in FIG. 11, a specified amount of conductive particles 3, for example, metal particles 302 (see FIG. 4), is discharged from nozzles 71 using known dispensers 70 while controlling the operating positions of the dispensers 70 with a robot or the like so that the conductive particles 3 are arranged at the same pitch as the pitch P of terminal portions 102t and terminal portions 113t in the width direction H, thus placing the conductive particles 3 on an insulating adhesive material 2 in the width direction H. Thereby, the plurality of conductive particles 3 can be placed on the insulating adhesive material 2 at the predetermined pitch P.

A second method of placing a plurality of conductive particles 3 on an insulating adhesive material 2 at a predetermined pitch P is a method to which a method of producing a package of an electronic component, for example, a ball grid array (BGA) or a chip size package (CSP), is applied.

Specifically, as shown in FIG. 12, first, spherical conductive particles 3 having a predetermined size, for example, having a particle diameter R of 10 μm as described above, are sucked into suction holes 75h of a bonding tool 75 which is a structure in which the suction holes 75h are arranged at the same pitch as the above-described pitch P in the width direction H.

Subsequently, as shown in FIG. 13, the bonding tool 75 is pressed onto an insulating adhesive material 2, and the suction from the suction holes 75h is stopped. Consequently, the conductive particles 3 that have been sucked in the suction holes 75h can be placed on the insulating adhesive material 2 at the predetermined pitch P.

Next, a third method of placing a plurality of conductive particles 3 on an insulating adhesive material 2 at a predetermined pitch P is a method using an ink jet method.

Specifically, as shown in FIG. 14, spherical conductive particles 3 having a predetermined size, for example, having a particle diameter R of 10 μm as described above, are discharged onto an insulating adhesive material 2 from discharge holes 80h of an ink jet head 80 functioning as a droplet discharge unit in which the discharge holes 80h are arranged at the same pitch as the above-mentioned pitch P in the width direction H. Thereby, the plurality of conductive particles 3 can be placed on the insulating adhesive material 2 at the predetermined pitch P.

Next, a fourth method of placing a plurality of conductive particles 3 on an insulating adhesive material 2 at a predetermined pitch P is a method using a solder printing.

Specifically, first, as shown in FIG. 15, a mask 85 having holes 85h, the number of which is the same as the number of terminal portions 102t, is placed on an insulating adhesive material 2. The holes 85h are arranged in the width direction H at the same pitch as the above-mentioned pitch P, and have a predetermined size, for example, a diameter of 10 μm as described above. Subsequently, by performing a method similar to a solder printing in which, for example, a metal material is supplied on the insulating adhesive material 2 through the holes 85h, the plurality of conductive particles 3 can be placed on the insulating adhesive material 2 at the predetermined pitch P.

The method of placing a plurality of conductive particles 3 on an insulating adhesive material 2 at a predetermined pitch is not limited to the methods described above, and may be another method.

Next, a method of electrically connecting an FPC terminal 113 of an FPC 112 to an external connection terminal 102 using a conductive adhesive film 1 thus prepared will be described with reference to FIG. 16. FIG. 16 is a view that schematically shows a state in which a conductive adhesive film is applied on an external connection terminal of a liquid crystal panel.

In order to simplify the figure, the number of terminal portions of the external connection terminal in FIG. 16 is smaller than that in FIG. 1. In addition, in FIG. 16, the number of conductive particles is also smaller than the actual number of conductive particles in accordance with the number of terminal portions of the external connection terminal.

When the external connection terminal 102 is electrically connected to the FPC terminal 113 using a conductive adhesive film 1 having a plurality of conductive particles 3 arranged on an insulating adhesive material 2 at a predetermined pitch P in the width direction H as shown in FIG. 10, first, the conductive adhesive film 1 is applied onto the external connection terminal 102 with high positional accuracy so that each of the conductive particles 3 is located only on a terminal portion 102t of the external connection terminal 102. Alternatively, the conductive adhesive film 1 may be applied onto the FPC terminal 113 so that each of the conductive particles 3 is located only on a terminal portion 113t of the FPC terminal 113. As a result, each of the conductive particles 3 is located only on the corresponding terminal portion 102t.

As the conductive adhesive film 1 used here may be a commercially available conductive adhesive film in which a plurality of conductive particles 3 are arranged on an insulating adhesive material 2 at a predetermined pitch P in the width direction H, or a conductive adhesive film produced as described above so that a plurality of conductive particles 3 are arranged on an insulating adhesive material 2 at a predetermined pitch P in the width direction H.

Subsequently, as shown in FIGS. 3 and 6, the FPC terminal 113 is applied onto the external connection terminal 102 by pressure bonding with the conductive adhesive film 1 therebetween. Specifically, the FPC terminal 113 is applied by pressure bonding so that each of the terminal portions 113t of the FPC terminal 113 faces a corresponding terminal portion 102t of the external connection terminal 102, with the conductive adhesive film 1 therebetween, in the thickness direction T.

As a result, as shown in FIG. 3, each of the terminal portions 102t is electrically connected to the corresponding terminal portion 113t via the conductive particle 3 located on the external connection terminal 102. Alternatively, as shown in FIG. 6, the conductive particles 3 located on the external connection terminal 102 are melted by heat applied during pressure bonding, thereby electrically connecting each of the terminal portions 102t to the corresponding terminal portion 113t by eutectic bonding.

In this case, as described above, the conductive particles 3 have a particle diameter R substantially the same as or somewhat smaller than the width M of the terminal portions 102t of the external connection terminal 102 and the terminal portions 113t of the FPC terminal 113 in the width direction H. Accordingly, a single conductive particle 3 can be reliably arranged between a pair of a terminal portion 102t and a terminal portion 113t, and thus the connection reliability between the first terminal and the second terminal is easily improved.

As described above, in this embodiment, an FPC terminal 113 of an FPC 112 is electrically connected to an external connection terminal 102 using a conductive adhesive film 1 in which a plurality of conductive particles 3 are arranged on an insulating adhesive material 2 at the same predetermined pitch as the pitch P of terminal portions 102t and the pitch P of terminal portions 113t in the width direction H.

According to this feature, when the external connection terminal 102 is bonded to the FPC terminal 113 with the conductive adhesive film 1 therebetween, each of the conductive particles 3 is reliably arranged only at a position where a terminal portion 102t faces the corresponding terminal portion 113t of the FPC terminal 113 in the thickness direction T. Accordingly, the connection reliability between the external connection terminal 102 and the FPC terminal 113 can be easily improved.

Furthermore, in this embodiment, in producing the conductive adhesive film 1, a plurality of conductive particles 3 are placed on an insulating adhesive material 2 of the conductive adhesive film 1 having a predetermined size so that the conductive particles 3 are arranged in the width direction H at the same predetermined pitch as the pitch P of the terminal portions 102t and the pitch P of the terminal portions 113t in the width direction H.

According to this feature, the conductive adhesive film 1 is produced by placing the conductive particles 3, the number of which is the minimum required for electrically connecting the terminal portions 102t to the terminal portions 113t, on the insulating adhesive material 2. Therefore, the production cost can be reduced compared with a case where a general-purpose conductive adhesive film in which a plurality of conductive particles 3 are diffused in an insulating adhesive material 2 at a high density is used for electrically connecting the external connection terminal 102 to the FPC terminal 113.

In addition, according to examples described in this embodiment, the conductive particles 3 are placed on the insulating adhesive material 2 by any one of a method using dispensers 70, a method to which a method of producing a package of an electronic component is applied, a method using an ink jet method, and a method using printing.

According to these methods, a plurality of conductive particles 3 can be reliably arranged on the insulating adhesive material 2 at high positional accuracy at a predetermined pitch.

Modifications will be described below. In the description of the above embodiment, a conductive adhesive film 1 in which a plurality of conductive particles 3 are arranged in the width direction H at a predetermined pitch is used for electrically connecting an external connection terminal 102 to an FPC terminal 113. That is, the first terminal is the external connection terminal 102 and the second terminal is the FPC terminal 113.

In addition, in the description of the above embodiment, a plurality of conductive particles 3 are arranged in the insulating adhesive material 2 at the same predetermined pitch as the pitch P of the terminal portions 102t of the external connection terminal 102 in the width direction H and the pitch P of the terminal portions 113t of the FPC terminal 113 in the width direction H.

The application of the conductive adhesive film 1 is not limited to the above. The conductive adhesive film 1 of this embodiment may be used for electrically connecting another first terminal to another second terminal of an electronic apparatus. In such a case, the same advantages as in the above embodiment can be achieved. In this case, a conductive adhesive film can be used in which a predetermined pitch of a plurality of conductive particles 3 in the width direction H is the same as the pitch of the first terminal in the width direction H and the pitch of the second terminal in the width direction H.

Furthermore, in producing the conductive adhesive film, a plurality of conductive particles 3 are placed on the insulating adhesive material 2 so that the predetermined pitch of the plurality of conductive particles 3 in the width direction H is the same as the pitch of the first terminal in the width direction H and the pitch of the second terminal in the width direction H.

In the above embodiment, a description has been made of an example in which the terminal portions 102t of the external connection terminal 102 and terminal portions 113t of the FPC terminal 113, the external connection terminal 102 and the FPC terminal 113 being connection objects, are arranged in a line in the width direction H. The arrangement is not limited thereto. The invention can be applied to terminal portions that are arranged in a plurality of lines or at random.

In such a case, a conductive adhesive film wherein when the conductive adhesive film is applied to either the terminal 102 or the terminal 113, conductive particles 3 are arranged so as to be located only on the terminal portions 102t or the terminal portions 113t may be used. Alternatively, a conductive adhesive film in which the conductive particles are arranged as described above may be produced. In these cases, the same advantages as in the above embodiment can be achieved.

Furthermore, in the description of this embodiment, a single conductive particle 3 is located between a pair of a terminal portion 102t and a terminal portion 113t facing each other, as shown in FIG. 10. However, assuming that the particle diameter R of the conductive particle 3 is 10 μm and considering that the width N of each of the terminal portion 102t and the terminal portion 113t in the extending direction E is 500 μm, by positioning two or more conductive particles 3 between a pair of a terminal portion 102t and a terminal portion 113t facing each other, the terminal portion 102t may be electrically connected to the terminal portion 113t.

Furthermore, in this embodiment, the conductive particles 3 are arranged in the insulating adhesive material 2 at a predetermined pitch P. In addition, the conductive particles 3 are placed on the insulating adhesive material 2 at the predetermined pitch P.

The structure is not limited thereto. Alternatively, the conductive particles 3 may be arranged in the insulating adhesive material 2 at a predetermined pitch P so that an area having a high density of the conductive particles 3 and an area having a low density of the conductive particles 3 are alternately arranged. In other words, in the placement described above, the conductive particles 3 may be arranged in the insulating adhesive material 2.

More specifically, in a conductive adhesive film 1 in which conductive particles 3 are diffused at a predetermined density, conductive particles 3 may further be arranged on an insulating adhesive material 2 at a predetermined pitch P, as in the above-described embodiment. In other words, in the placement descried above, conductive particles 3 may be arranged at a predetermined pitch P on such a conductive adhesive film 1 in which conductive particles 3 are diffused at a predetermined density.

The liquid crystal panel is not limited to the above-described example shown in the figures, and various modifications can be made within the scope of the invention. For example, the liquid crystal panel has been described using an active matrix liquid crystal display module including active elements such as thin film transistors (TFTs) as an example. The liquid crystal panel is not limited thereto and may be an active matrix liquid crystal display module including active elements such as thin film diodes (TFDs).

Furthermore, in this embodiment, an electro-optical device has been described using a liquid crystal device as an example. The invention is not limited thereto and can be applied to various types of electro-optical devices such as electroluminescent devices, in particular, for example, an organic electroluminescent device or an inorganic electroluminescent device, a plasma display device, a field emission display (FED) device, a surface-conduction electron-emitter display (SED) device, a light-emitting diode (LED) display device, an electrophoretic display device, and a device including a thin cathode-ray tube or a liquid crystal shutter.

Alternatively, the electro-optical device may be a device for display in which elements are formed on a semiconductor substrate, for example, a liquid crystal on silicon (LCOS). In the LCOS, a single-crystal silicon substrate is used as an element substrate, and transistors are formed on the single-crystal silicon substrate as switching elements used for pixels and peripheral circuits. Reflective pixel electrodes are used in the pixels, and elements of the pixels are formed on an underlayer of the pixel electrodes.

Alternatively, the electro-optical device may be a device for display in which a pair of electrodes are formed on the same layer of one of substrates, for example, an in-plane switching (IPS), or a device for display in which a pair of electrodes are formed on one of substrates with an insulating film therebetween, for example, fringe field switching (FFS).

Furthermore, an electronic apparatus has been described using an electro-optical device as an example. However, the invention can be applied to other devices.

The entire disclosure of Japanese Patent Application No. 2008-034119, filed Feb. 15, 2008 is expressly incorporated by reference herein.

What is claimed is:

1. A conductive adhesive film comprising:
an insulating adhesive material; and
a plurality of conductive particles dispersed in the insulating adhesive material,
wherein the conductive particles are arranged in the insulating adhesive material at a predetermined pitch.

2. A conductive adhesive film comprising:
an insulating adhesive material; and
a plurality of conductive particles dispersed in the insulating adhesive material, p1 wherein an area having a high density of the conductive particles and an area having a low density of the conductive particles are alternately arranged at a predetermined pitch.

3. The conductive adhesive film according to claim 1,
wherein the conductive adhesive film electrically connects a first terminal to a second terminal,
each of the first terminal and the second terminal includes a plurality of terminal portions arranged in a first direction, and
the pitch is determined in accordance with a pitch of the terminal portions in the first direction.

4. The conductive adhesive film according to claim 3, wherein the conductive particles have a particle diameter substantially the same as a width of the terminal portions of the first terminal and the second terminal in the first direction.

5. The conductive adhesive film according to claim 1, wherein the conductive particles are metal particles.

6. The conductive adhesive film according to claim 1, wherein the conductive particles are resin core particles each composed of a resin coated with a metal plating film.

7. The conductive adhesive film according to claim 1, wherein the conductive particles electrically connect a first terminal to a second terminal.

8. The conductive adhesive film according to claim 1, wherein the conductive particles are melted by applying heat and electrically connect a first terminal to a second terminal by eutectic bonding.

9. A method of producing a conductive adhesive film including an insulating adhesive material and a plurality of conductive particles dispersed in the insulating adhesive material, comprising:
placing the conductive particles on the insulating adhesive material so that the conductive particles are arranged in the insulating adhesive material at a predetermined pitch.

10. A method of producing a conductive adhesive film including an insulating adhesive material and a plurality of conductive particles dispersed in the insulating adhesive material, comprising:
placing the conductive particles on the insulating adhesive material so that an area having a high density of the conductive particles and an area having a low density of the conductive particles are alternately arranged at a predetermined pitch.

11. The method according to claim 9,
wherein the conductive adhesive film electrically connects a first terminal to a second terminal,
each of the first terminal and the second terminal includes a plurality of terminal portions arranged in a first direction, and
the placement of the conductive particles on the insulating adhesive material at a predetermined pitch is performed in accordance with a pitch of the terminal portions in the first direction.

12. The method according to claim 9, wherein the placement of the conductive particles is performed using a dispenser.

13. The method according to claim 9, wherein the placement of the conductive particles is performed by a method of producing a package of an electronic component including sucking the conductive particles into a structure having suction holes provided at the predetermined pitch, and placing the sucked conductive particles from the structure onto the insulating adhesive material.

14. The method according to claim 9, wherein the placement of the conductive particles is performed using a droplet discharge unit.

15. The method according to claim 9, wherein the placement of the conductive particles is performed by printing.

16. An electronic apparatus comprising:
the conductive adhesive film according to claim 1,
wherein the conductive adhesive film is used for providing an electrical connection between a first terminal and a second terminal.
